(19) United States
(12) Patent Application Publication
(10) Pub. No.: US 2011/0031660 A1
(43) Pub. Date: Feb. 10, 2011

(54) METHOD OF FORMING A MUFFLER PREFORM

(76) Inventors: Norman T. Huff, Brighton, MI (US); Janakikodandaram Karra, Novi, MI (US); Gareth Knoll, Northville, MI (US)

Correspondence Address: Calfee, Halter & Grlswold LLP, 800 Superior Ave E, Suite 1400, Cleveland, OH, 44114, US

(21) Appl. No.: 12/535,936

(22) Filed: Aug. 5, 2009

(51) Int. Cl. B29C 39/42

(52) U.S. Cl. 264/571; 425/405.1

(57) ABSTRACT

A method of forming a preform product includes filling a mold cavity with glass fibers. The mold cavity has an inlet end, a second end opposite the inlet end, and a longitudinal axis. Suction is applied simultaneously to the mold cavity axially from the second end, and suction is further simultaneously applied radially inwardly from a longitudinal passage within the mold cavity, thereby forming a preform product.

### BACKGROUND OF THE INVENTION

The present invention relates generally to preforms, and more particularly to compacted glass fiber preforms that are produced directly from a glass fiber product formed of texturized continuous glass fibers.

Acoustical sound insulators are used in a variety of settings where it is desired to reduce noise emissions by dissipating or absorbing sound. For example, it is known in the art to use a sound absorbing material in exhaust mufflers of internal combustion engines to dampen or attenuate sound made by the engine exhaust gases as they pass from the engine through the exhaust system and into the atmosphere. Typically, continuous glass fiber strands are positioned internally in a muffler as the sound absorbing material. Continuous glass fibers are preferred over other fibers, such as chopped glass fibers, because the length of the continuous fibers decreases the possibility that free fibers may dislodge from the muffler and exit into the atmosphere.

Continuous glass fiber strands may be positioned in a muffler by a variety of methods known in the art. For example, continuous glass fiber strands may be inserted directly into a muffler shell, such as is disclosed in U.S. Pat. No. 4,569,471 to Ingemansson et al. In particular, Ingemansson et al. disclose a process and apparatus for filling muffler shells by feeding continuous multifilament glass fiber strands through a nozzle and into a muffler outer shell. Compressed air is used to expand the fiber strands into a wool-like material inside the shell.

Alternatively, fibrous filled bags may be utilized to fill the inner cavities of a muffler. U.S. Pat. No. 6,607,052 to Brandt et al. discloses a process for filling a muffler shell with continuous glass fiber strands in which a bag is filled with continuous glass fibers and inserted into a muffler cavity. The bag has a first side with one or more first perforations defining a first side total open area and a second side with either no perforations or one or more second perforations defining a second side total open area. The first side total open area is greater than the second side total open area. The bag is filled with a fibrous material (e.g., continuous glass fiber strands) and positioned adjacent to an internal structure located within a first muffler shell part. A partial vacuum is applied to draw the filled bag towards the internal structure. A second muffler shell part is then placed adjacent to the first muffler shell part such that the first and second muffler shell parts define an internal cavity containing the internal structure and the fibrous material-filled bag.

In addition to filling a muffler shell with continuous glass fiber strands, it is also known in the art to form preforms of continuous glass fiber strands which are adapted to be inserted into a muffler shell. U.S. Pat. No. 5,766,541 and EP 0 941 441 to Knutsson et al. discloses a preform of continuous glass fiber strands made by feeding continuous glass fiber strands into a perforated mold to form a continuous wool product in the mold, feeding a binder into the mold, compressing the mold to compact the wool product to a desired density, heating the mold to cure the binder, and removing the preform from the mold. The preform may then be inserted into a muffler cavity.

In U.S. Patent Publication No. 2001/0011780 A1 and EP 0 692 616 to Knutsson, continuous glass fiber strands and a powder binder are blown into a cavity formed of a perforated screen having the shape of the muffler to be filled. Hot air is then passed through the perforated screen to melt the binder and bond the fibers together. Next, cool air is circulated through the screen to cool the preform so that it can be removed from the screen and inserted into a muffler.

In many of the methods in existence for forming muffler preforms, a binder is applied to the fibers prior to filling a muffler mold with the fibers. Generally, the binder is sprayed onto the glass fibers during the texturization of the fibers to form a wool-like material. The binder conventionally used in muffler preforms is a thermosetting, phenolic-based resin. The phenolic-based resin is in a powder form and is sprayed onto the fibers with water to reduce dusting and aid in helping the powder to stick to the glass fibers before curing. After curing, thermosetting binders generally form cross-linked products through irreversible cross-linking reactions. Thus, once the binder in contact with the fibers is cured, such as in an oven, the cured binder holds or retains the fibers in the shape of the preform until the preform is installed into a muffler shell. After the preform is installed in the muffler shell, the binder is no longer needed, and is typically burned off by running the vehicle for a period of time sufficient to remove at least a substantial portion of the binder from the preform. It is desirable however, to provide an improved method of forming a muffler preform.

### SUMMARY OF THE INVENTION

The present invention relates to compacted glass fiber preforms produced directly from a glass fiber product formed of texturized continuous glass fibers. In one embodiment of a method of forming a preform product, a mold cavity is filled with glass fibers. The mold cavity has an inlet end, a second end opposite the inlet end, and a longitudinal axis. Suction is applied simultaneously to the mold cavity axially from the second end, and suction is further simultaneously applied radially inwardly from a longitudinal passage within the mold cavity, thereby forming a preform product.

In another embodiment of the method of forming a preform product, a preform product is formed within a muffler shell. A muffler shell cavity is filled with glass fibers. The muffler shell cavity has an inlet end and a second end opposite the inlet end. A perforated tube extends from the first end to the second end of the cavity. Suction is applied simultaneously to the muffler shell cavity axially from the second end, and suction is further simultaneously applied radially inwardly through apertures formed in the perforated tube, thereby forming a preform product within a muffler shell.

In an additional embodiment, a mold for forming a preform product is provided. The mold has a first end and a second end and includes an outer mold portion. The outer mold portion has a longitudinal axis, a first end, and a second end. An inner mold portion is disposed longitudinally within the outer mold portion. A substantially annular space between the inner mold portion and the outer mold portion defines a mold cavity. The inner mold portion includes a closed first end, an open second end, and a plurality of apertures formed therethrough. An end plate is disposed at the second end of the mold and has a centrally formed opening and a plurality of vacuum holes formed therein. The centrally formed opening defines a passage into a cavity formed in the inner mold portion, and the vacuum holes define passages into the mold cavity. A vacuum source is disposed adjacent the second end of the mold.

Other advantages of the invention will become apparent to those skilled in the art from the following detailed description, when read in light of the accompanying drawings.

### BRIEF DESCRIPTION OF THE DRAWINGS

FIG. 1 is a flow diagram illustrating the steps for forming a preform according to an exemplary embodiment of the present invention.

FIG. 2 is a partially exploded perspective view of a first embodiment of a mold for forming preform for a muffler.

FIG. 3 is an exploded cross sectional view taken along line 3-3 of FIG. 2.

FIG. 4 is a cross sectional view of the mold illustrated in FIG. 2 showing the nozzle introduced into the mold assembly.

FIG. 5 is a cross sectional view of the mold illustrated in FIGS. 2 and 4 showing the mold partially filled with texturized glass fibers.

FIG. 6 is a cross sectional view of the mold illustrated in FIGS. 2, 4, and 5 showing the mold filled with texturized glass fibers.

FIG. 7 is an enlarged perspective view of the outer tube illustrated in FIG. 2 in a partially open position.

FIG. 8 is an enlarged view of a portion of the inner tube and mold lid illustrated in FIG. 2.

FIG. 9 is a perspective view of a muffler preform formed in accordance with the method of the invention.

FIG. 10 is a partially exploded cross-sectional view of an alternate embodiment of the invention, showing a muffler shell prior to being filled with texturized glass fibers.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about,” Accordingly, unless otherwise indicated, the numerical properties set forth in the specification and claims are approximations that may vary depending on the desired properties sought to be obtained in embodiments of the present invention, Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

As used in the description of the invention and the appended claims, the word/phrase “texturized fiber” is defined as glass strands wherein compressed air has separated the fibers forming the strands into individual fibers to give the fibers a “fluffed-up” or wool-like appearance. Additionally, the fibers can be “texturized” by other means, such as through mechanical handling of the fibers.

All references cited herein, including published or corresponding U.S. or foreign patent applications, issued U.S. or foreign patents, or any other references, are each incorporated by reference in their entireties, including all data, tables, figures, and text presented in the cited references.

Referring now to the drawings, there is shown at 10 in FIG. 1 an exemplary embodiment of the steps for forming a preform product or preform for a muffler. In a first step 12 of the manufacturing process, binder coated texturized fiber strands are introduced into a mold cavity. In a second step 14, suction is applied simultaneously from an end surface and an interior of the mold cavity. Preforms formed in accordance with the method described herein are capable of being incorporated into vehicle exhaust systems to function as acoustic attenuators.

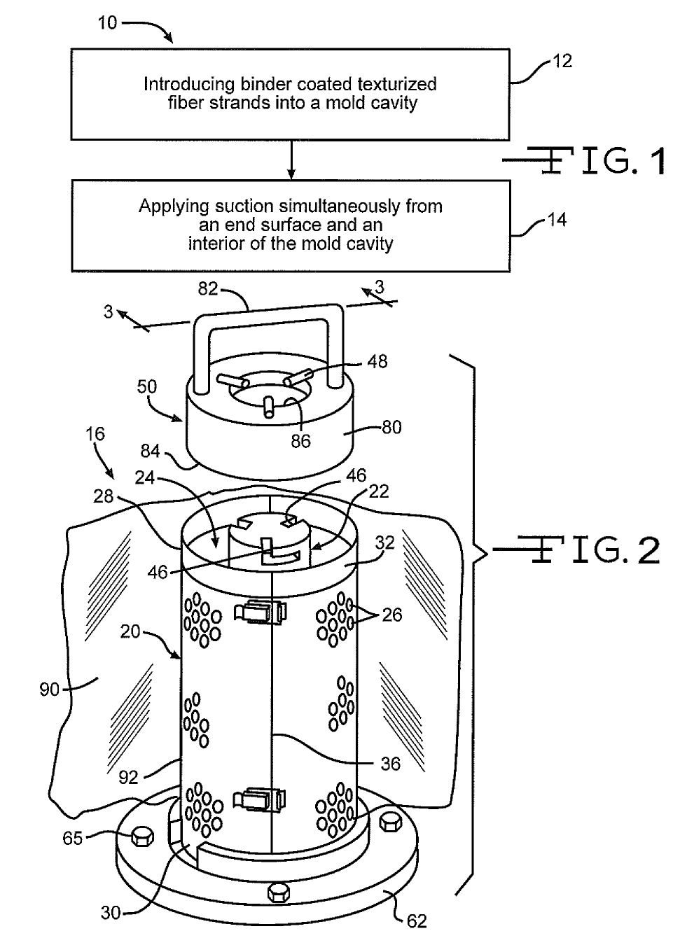

Referring again to the drawings, there is shown in FIGS. 2 through 8, a first embodiment of a mold 16 for forming a preform 18 for a muffler according to the invention. The illustrated mold 16 includes a first or outer mold portion 20 and a second or inner mold portion 22. A substantially annular space or mold cavity 24 is defined between the inner and outer mold portions, 22 and 20, respectively. In the illustrated embodiment, the mold portions 20 and 22 include a plurality of apertures 26 formed therethrough. Any desired number of apertures 26 may be formed through the mold portions 20 and 22. For example, in the illustrated embodiment, the apertures 26 define about 50 percent of the surface area of the mold portions 20 and 22.

Alternatively, the apertures 26 may define any desired portion of the surface area of the mold portions 20 and 22, such as within the range of from about 30 percent to about 70 percent of the surface area of the mold portions 20 and 22.

It will be understood that the apertures 26 in both the inner and outer mold portions 22 and 20, respectively, advantageously make a steam curing process, as described below, or a hot air curing process, such as a forced hot air process, more efficient.

The illustrated mold portions 20 and 22 may be formed from any suitable material. Examples of suitable materials include steel, engineered plastics, aluminum, and other suitable metals and non-metals. Any other substantially rigid material may also be used. If desired, the outer mold portion 20 may be formed of mesh material, such as wire mesh, to maximize the amount of surface area of the outer surface 92 that is open. Alternatively, either or both of the outer mold portion 20 and the inner mold portion 22 may be formed of a supported mesh material, e.g., the mesh material could be wrapped around substantially rigid rods or bars which provide a support for the mesh material.

In the illustrated embodiment, the outer mold portion 20 is substantially cylindrical in shape, and has a first end 28 (upper end when viewing FIG. 2) and a second end 30 (lower end when viewing FIG. 2). The first end 28 may include a portion 32 having no apertures. Alternatively, apertures may be provided along the entire longitudinal length of the outer mold portion 20. In other embodiments, the outer mold portion 20 may have other geometric shapes, such as an elliptic or rectangular transverse cross-sectional shape. Alternatively, the outer mold portion 20 may have the general shape of the muffler shell into which the preform 18 will be inserted.

As best shown in FIG. 7, the outer mold portion 20 may include an axially extending hinge 34 and an axially extending seam 36 defining an opening substantially 180 degrees opposite the hinge 34. One or more latches 38 may be provided at the seam 36 to selectively latch and unlatch the opening at the seam 36. The purpose and function of the hinge 34 will be described in detail herein below.

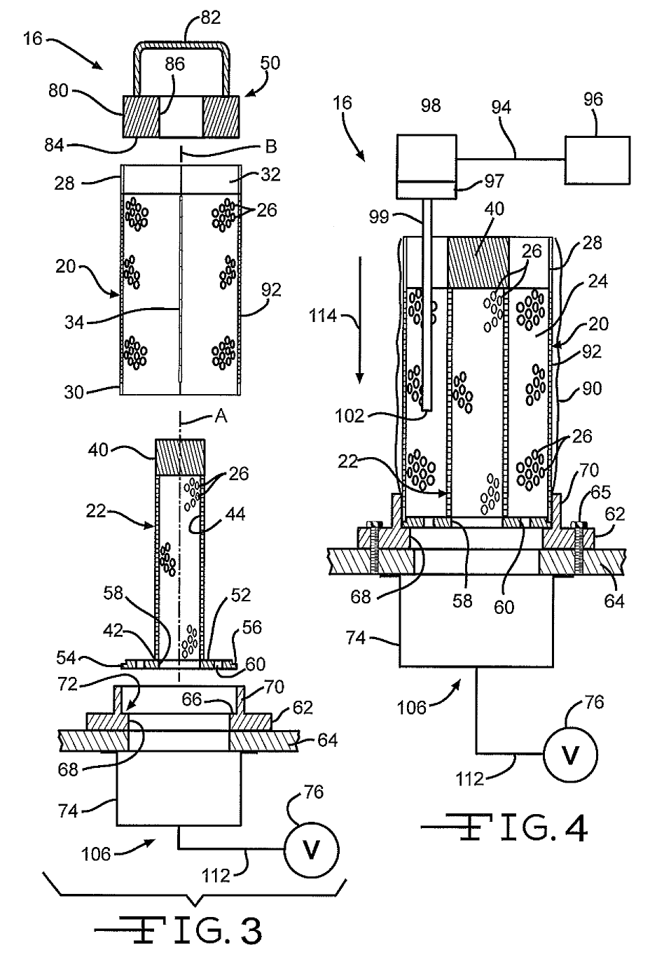

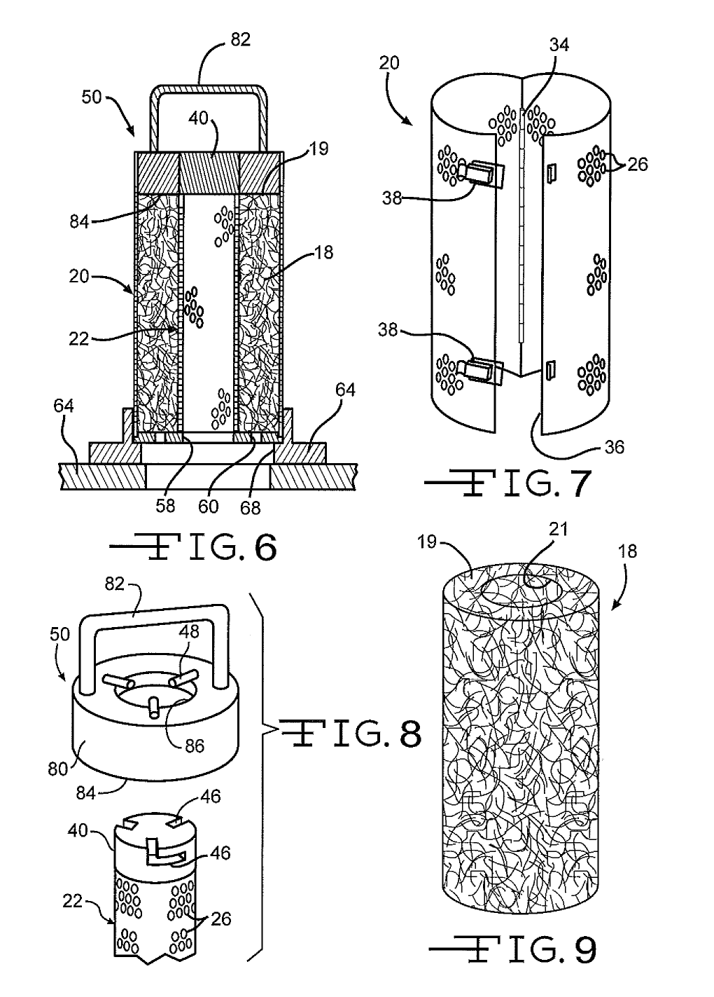

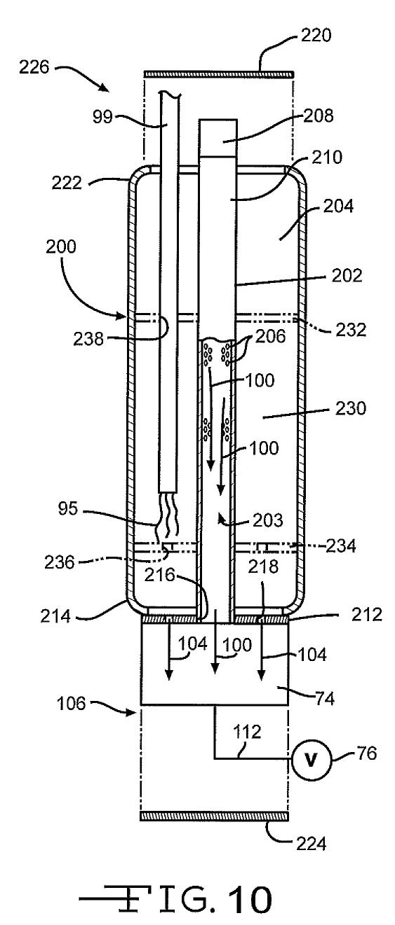

In the illustrated embodiment, the inner mold portion 22 is substantially cylindrical in shape, has a first or closed end 40 (upper end when viewing FIGS. 3 and 8) a second or open end 42 (lower end when viewing FIG. 3), and defines a substantially cylindrical inner mold cavity 44. The inner mold portion 22 may be concentrically located within the outer mold portion 20. Alternatively, the inner mold portion 22 may be located at any desired location within the outer mold portion 20 such that the axis A of the inner mold portion 22 is substantially parallel with the axis B of the outer mold portion 20. In other embodiments, the inner mold portion 22 may have other geometric shapes, such as an elliptic or rectangular transverse cross-sectional shape. Alternatively, the inner mold portion 22 may have the general shape of a perforated or solid tube within a muffler shell into which the preform 18 will be inserted. The preform 18 illustrated in FIG. 9 has one bore 21. It will be understood that the preform 18 may be formed having any number of non-concentric bores. Accordingly, the mold 16 may included any desired number of non-concentric inner mold portions 22, including two or more inner mold portions 22.

The closed end 40 of the inner mold portion 22 may include a plurality of substantially L-shaped slots 46 for receiving locking pins 48 of a mold lid 50, the purpose for which will be described in detail herein below. A substantially planar flange 52 extends radially outwardly from the second end 42 of the inner mold portion 22. The illustrated flange 52 has a circular circumferential edge 54 and includes a circumferentially extending notch 56 formed in the edge 54. The notch 56 defines a seat for the outer mold portion 20. The flange 52 includes a centrally formed opening 58 having a diameter substantially equal to or smaller than the inner diameter of the inner mold portion 22. A plurality of vacuum holes 60 are formed in the flange 52. In the illustrated embodiment, seven vacuum holes 60 are formed in the flange 52. Alternatively, any desired number of vacuum holes may be formed in the flange 52.

A substantially annular mold base 62 may be provided for mounting the mold 16 to a structure such as a table 64. The mold base 62 may be mounted to the table 64 by any suitable fasteners, such as threaded fasteners 65. The illustrated mold base 62 includes a mounting surface 66 surrounding a centrally formed opening 68 having a diameter slightly smaller than the outer diameter of the flange 52. A cylindrical flange 70 extends outwardly (upwardly extending when viewing FIGS. 2 and 3) from the mold base 62. The flange 70 and the mounting surface 66 together define a seat 72 for the flange 52 of the inner mold portion 22. As will be described in detail below, the mold base 62 is coupled to a vacuum adapter, schematically illustrated at 74. The vacuum adapter 74 is further coupled to a vacuum source 76.

A mold lid 50 includes a substantially annular body 80 with an outwardly extending handle 82 (upwardly extending when viewing FIGS. 2 and 8). The body 80 has a planar first surface 84 (lower surface when viewing FIG. 3) and a centrally formed opening 86 having a diameter slightly larger than the outer diameter of the inner mold portion 22. The planar first surface 84 is structured and configured to engage and compress an upper surface 19 of a preform 18. It will be understood that the handle 82 is not required. Alternatively, the surface 84 of the lid 50 may have any desired shape, such as conical or frustoconical.

The outer diameter of the body 80 is slightly smaller than the inner diameter of the outer mold portion 20. The body 80 is structured and configured to be mounted within the outer mold portion 20 and about the inner mold portion 22, as best shown in FIGS. 2, 6, and 8. In the illustrated embodiment, locking pins 48 are mounted to the body 80 and extend radially inwardly into the opening 86. The pins 48 are structured and configured to engage the slots 46 of the closed end 40 of the inner mold portion 22. It will be understood that the lid 50 may be secured to the mold 16 by any other desired means, and further may be secured to either or both of the inner mold portion 22 or the outer mold portion 20.

Prior to manufacturing the preform 18, air-impermeable material 90 is disposed around the outer surface 92 of the outer mold portion 20. The air-impermeable material 90 may be any desired material, such as plastic or cloth. Alternatively, a cylindrical sleeve (not shown) having an outer diameter slightly smaller than the inner diameter of the outer mold portion 20 may be inserted into the outer mold portion 20. If desired, the outer mold portion 20 may be formed without apertures, thereby defining an air-impermeable barrier without the need for an air-impermeable material 90 to be disposed around the outer surface 92.

It has been shown that in certain embodiments, it is desirable to allow a very small amount of air to flow through the material covering the apertures 26 in the outer mold portion 20. Therefore, in an alternate embodiment of the mold 16, a high air-flow resistant material may be used. Advantageously, such high air-flow resistant material reduces the amount of binder that may collect in the apertures 26 in the outer mold assembly 20.

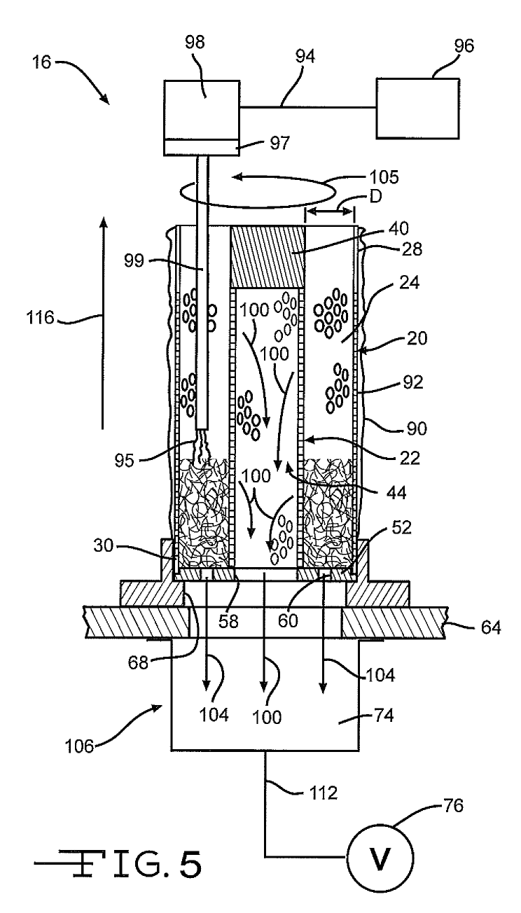

Referring now to FIG. 4, the mold 16 is illustrated prior to receiving continuous strands 94. In the illustrated embodiment, continuous strands 94 are supplied from a doff (not shown) to a strand feeder 96. The strand feeder 96 may include one or more strand feeding mechanisms that feed one or more continuous strands 94 of glass fibers into a texturizing nozzle 98 of a texturizing device, such as the texturizing nozzle of the SILENTEX® system by Owens Corning described in U.S. Pat. No. 5,976,453. A powder binder application device 97 is attached between the texturizing nozzle 98 and a nozzle extension 99. The strand feeder 96, texturizing nozzle 98, powder binder application device 97, and nozzle extension 99 are schematically illustrated in FIGS. 4 and 5.

To fill the mold cavity 24 with a desired amount of glass fibers, the nozzle extension 99 is moved into (downwardly when viewing FIG. 4) the mold cavity 24 in the direction of the arrow 114 until an outlet end 102 of the nozzle extension 99 is positioned in the mold cavity 24 at a depth of within the range of from about ½ to about ¾ of the length of the mold cavity 24. The feeder 96 controls the speed or rate at which the continuous glass strands 94 are fed into the nozzle 98. The feeder 96 may include a metering device to measure and control the amount of the continuous glass strands 94 that are inserted into the mold cavity 24. The depth that the nozzle extension 99 is inserted into the cavity 24 may also be determined as a function of the number and size of the holes 60 in the flange 52 and the suction provided by the vacuum source 76.

The glass used to form the continuous strands 94 may be any type of glass suitable to withstand the temperatures present in the muffler. In dissipating the sound from internal combustion engines, the exhaust gases require the use of high temperature fibers. Examples of suitable glass fibers include E-type glass fibers, S-type glass fibers, and ADVANTEX® glass fibers. Alternatively, other types of heat resistant continuous fibers such as carbon fibers, mineral fibers, (i.e., continuous basalt fibers) may be used. If high temperatures are not present in the muffler, synthetic fibers such as polyamide, aramid, polyaramid, and/or polypropylene, and the like may be used and/or comingled with the glass fibers to form the preform product. Glass fibers are often used in mufflers for internal combustion engines because of their sound attenuation capability and resistance to the extreme heat conditions, such as those produced within a muffler.

Referring now to FIG. 5, the nozzle extension 99 blows texturized glass fibers 95 into the mold cavity 24 through the first end 28 of the outer mold portion 20. The air may be pressurized by a conventional compressor and supplied by a hollow conduit in direct communication with the nozzle extension 99. As the texturized glass fibers 95 are fed into the mold cavity 24 through the texturizing nozzle 98, the expansion of the air flow separates the fibers forming the glass strands and entangles the individual fibers to give the fibers a “fluffed-up” or wool-like appearance (i.e., texturize the glass fibers).

In one embodiment, the diameter of the nozzle extension 99 is equal to about ¾ of the distance D between the outer and inner mold portions 20 and 22, respectively. In another embodiment, the diameter of the nozzle extension 99 is within the range of from about 12 mm to about 80 percent of the distance D between the outer and inner mold portions 20 and 22, respectively. It will be understood that although the illustrated embodiment depicts the use of texturized glass fibers, non-texturized glass fibers may alternatively be used to form a preform product.

Additionally, as the texturized glass fibers 95 are fed into the mold cavity 24, the nozzle extension 99 moves outwardly (upwardly when viewing FIG. 5) in the direction of the arrow 116 and circumferentially, such as shown by the arrow 105, about the inner mold portion 22, so as to define a helical movement pattern.

In the illustrated embodiment, a binder, such as a powder binder, is applied to the texturized glass fibers 95 immediately after texturization in the texturizing nozzle 98 and before the glass fibers 95 enter the nozzle extension 99. The binder may be any desired binder, such as a thermosetting, phenolic-based resin. Such a phenolic-based resin is in a powder form and is sprayed onto the texturized glass fibers 95 with water. After the preform 18 is cured, thermosetting binders generally form cross-linked products through irreversible cross-linking reactions. Thus, once the binder in contact with the fibers 95 is cured, such as in an oven, the cured binder holds or retains the fibers 95 in the shape of the preform until the preform is installed into a muffler shell. After the preform is installed in the muffler shell, the binder is no longer needed, and is typically burned off by running the vehicle for a period of time sufficient to remove at least a substantial portion of the binder from the preform.

As best shown in FIG. 5, a vacuum system 106 is provided. The vacuum system 106 includes a vacuum adapter 74 (schematically illustrated in the figures) attached to the table 64, and further coupled to a vacuum source 76 by a hose or pipes 112. A dust filter (not shown) may be provided between the mold 16 and the vacuum source 76.

Simultaneous with the introduction of the texturized glass fibers 95 into the mold cavity 24, a vacuum is applied to the mold cavity 24 to create a partial vacuum within the mold cavity 24. The partial vacuum provides for even distribution of the glass fibers 95, and further guides or directs the texturized glass fibers 95 within the mold cavity 24. The vacuum source 76 creates a suction which gathers any small, broken glass fibers, and also draws binder power that did not adhere to the texturized glass fibers 95 into the vacuum system 106 and, if provided, the dust filter.

Suction created by the vacuum system 106 is simultaneously applied (1) to the mold cavity 24 radially inwardly through the apertures 26 in the inner mold portion 22 through the inner mold cavity 44, through the opening 58, as shown by the arrows 100, and (2) to the mold cavity 24 through the second end 30 of the outer mold portion 20 through the plurality of vacuum holes 60 formed in the flange 52, as shown by the arrows 104.

Advantageously, the suction created by the simultaneous application of a vacuum through the inner mold cavity 44 and to the second end 30 of the outer mold portion 20, allows the fibers 95 to be deposited in the cavity 24 in an even and reproducible manner. It will be understood that the distribution of fibers 95 in the cavity 24 may be altered or adjusted by selecting the number, size and pattern of holes 60 in the flange 52 and/or by selecting the number, size and pattern, of apertures 26 in the inner mold portion 22 and by adjusting the suction created by the vacuum source 76.

In the embodiment of the mold 16 described herein above wherein the outer mold portion 20 is formed with the apertures 26 and the inner mold portion 22 has no apertures, the entire mold assembly may be placed in a container such that the suction created by the vacuum source is applied from outside the outer mold portion 20 and if desired, through the holes 60 in the flange 52, as described above. Advantageously, such an embodiment would provide for improved control of the powder binder, keeping it out of the work area. As a further advantage, the suction created by the simultaneous application of a vacuum through outside the outer mold portion 20, allows the fibers 95 to be deposited in the cavity 24 in an even and reproducible manner.

In an alternative embodiment of the mold 16, the outer mold portion 20 is formed with the apertures 26 and the inner mold portion 22 is also formed with the apertures 26. The entire mold assembly may be placed in a container such that the suction created by the vacuum source is applied from outside the outer mold portion 20 and if desired, through the opening 58 and the apertures 26 in the inner mold portion 22, and through the holes 60 in the flange 52.

It will be understood that the distribution of fibers 95 in the cavity 24 may be altered or adjusted by selecting the number, size and pattern of holes 60 in the flange 52 and/or by selecting the number, size and pattern, of apertures 26 in the outer mold portion 20 and by adjusting the suction created by the vacuum source 76.

After the mold cavity 24 has been filled with the desired amount of fibers 95, the lid 50 is attached to the inner mold assembly within the mold cavity 24, as best shown in FIG. 6. The planar first surface 84 of the lid 50 engages the preform 18. As the lid 50 is locked onto the inner mold portion 22, the lid 50 exerts a force on the preform 18 (downwardly when viewing FIG. 6), thereby forming the substantially planar upper surface 19. The air impermeable material 90 may then be removed from the mold 16.

Once formed, the preform 18 may be cured by any desired method, such as by directing hot air through the apertures 26 of the outer mold portion 20 and/or the apertures 26 of inner mold portion 22. Alternatively, the mold 16 may be placed in an oven and heated by radiation, convection, or a combination thereof. High-pressure steam may also be used as the source of heat to cure the binder. Once cured, the lid 50 may be removed, the outer mold portion 20 may be pivotally opened at the hinge 34, and the preform 18 may be removed from about the inner mold portion 22. The preform 18 may then be inserted into the cavity of a muffler shell.

If desired, a preform such as the preform 18 may be formed within a muffler shell. For example, a muffler may be directly filled with texturized fibers 95 without the necessity of applying a binder to the roving as shown in FIG. 10. FIG. 10 illustrates an alternate embodiment of the invention in which the muffler shell 200 functions as a mold. The muffler shell 200 includes a centrally disposed perforated tube 202 having perforations 206 and defining a tube cavity 203. A temporary cap 208 is removably attached to a first end 210 (upper end when viewing FIG. 10). A fill plate 212 is removably attached to a second end 214 (lower end when viewing FIG. 10) of the shell 200. The plate 212 includes a centrally formed opening 216. A plurality of vacuum holes 218 are formed in the plate 212. The plate functions in the same manner as the flange 52 described herein above. Any desired number of vacuum holes 218 may be formed in the plate 212. As further described above, the vacuum system 106 is provided. The vacuum system 106 includes the vacuum adapter 74 (schematically illustrated in the figures) coupled to the vacuum source 76 by a hose or pipe 112. A dust filter (not shown) may be provided between the shell 200 and the vacuum source 76. In the illustrated embodiment, the vacuum adapter 74 is attached to the plate 212. Alternatively, shell and the vacuum adapter 74 may be attached to a structure such as a table (not shown in FIG. 10).

In an alternative embodiment of the muffler shell 200, a chamber 230 is defined within the muffler shell by a first baffle 232 and a second baffle 234. The baffles 232 and 234 are illustrated by phantom line in the embodiment illustrated in FIG. 10. In the illustrated embodiment, the second baffle 234 has a plurality of holes 236 and the first baffle 232 has a hole 238 for the nozzle extension 99. In such an embodiment, the chamber 230 may be filled with glass fibers 95 as suction is simultaneously applied through the perforated tube 202 and through the holes 236, as described herein above. If desired, for example in muffler shells having more than one perforated tube, the baffle 232 may have more than one hole 238.

As described above, simultaneous with the introduction of the texturized glass fibers 95 into the muffler cavity 204, a vacuum is applied to the cavity 204 to create a partial vacuum within the cavity 204. The partial vacuum provides for even distribution of the glass fibers 95, and further guides or directs the texturized glass fibers 95 within the muffler cavity 204. Suction created by the vacuum system 106 is simultaneously applied to the tube cavity 203 of the perforated tube 202 through the opening 216, and to the second end 214 of the shell 200 through the plurality of vacuum holes 218 formed in the plate 212, as shown by the arrows 100 and 104, respectively.

After the muffler cavity 204 has been filled with the desired volume of fibers 95, a first end plate 220 may be attached to a first end 222 of the shell 200. The plate 212 may also be removed and a second end plate 224 attached to the second end 214 of the shell 200. The first and second plates 220 and 224, respectively, may be attached to the shell 200 by any desired means, such as by welding, by crimping, or with fasteners such as rivets or threaded fasteners, thereby completing a fiber filled muffler assembly 226. In an alternative embodiment, in lieu of the plates 220 and 224, the ends 214 and 222 of the muffler shell 200 may be rolled into a conical shape about the distal ends of the perforated tube 202.

The principle and mode of operation of this invention have been described in its preferred embodiments. However, it should be noted that this invention may be practiced otherwise than as specifically illustrated and described without departing from its scope.

What is claimed is:

1. A method of forming a preform product, the method comprising:
filling a mold cavity with glass fibers, the mold cavity defining an inlet end, a second end opposite the inlet end, and a longitudinal axis; and
simultaneously applying suction to the mold cavity axially from the second end and further simultaneously applying suction radially inwardly from a longitudinal passage within the mold cavity, thereby forming a preform product.

2. The method according to claim 1, wherein the glass fibers are continuous glass fibers.

3. The method according to claim 1, wherein the glass fibers are texturized glass fibers.

4. The method according to claim 3, wherein the texturized glass fibers are deposited in the mold cavity through the inlet end by a nozzle.

5. The method according to claim 4, wherein the nozzle moves in the direction of the inlet end of the mold cavity and circumferentially about the longitudinal passage to define a helical movement pattern as the nozzle deposits the texturized glass fibers in the mold cavity.

6. The method according to claim 1, wherein upon filling the mold cavity with a desired volume of glass fibers, a force is applied onto the preform product at the inlet end of the mold cavity to define a substantially planar surface on the preform.

7. The method according to claim 6, further including curing the preform in the mold.

8. A method of forming a preform product within a muffler shell, the method comprising:
filling a muffler shell cavity with glass fibers, the muffler shell cavity defining an inlet end and a second end opposite the inlet end, and having a perforated tube extending from the first end to the second end of the cavity; and
simultaneously applying suction to the muffler shell cavity axially from the second end and further simultaneously applying suction radially inwardly through apertures formed in the perforated tube, thereby forming a preform product.

9. The method according to claim 8, wherein the glass fibers are continuous glass fibers.

10. The method according to claim 8, wherein the glass fibers are texturized glass fibers.

11. The method according to claim 10, wherein the texturized glass fibers are deposited in the muffler shell cavity through the inlet end by a nozzle.

12. The method according to claim 11, wherein the nozzle moves in the direction of the inlet end of the muffler shell cavity and circumferentially about the perforated tube to define a helical movement pattern as the nozzle deposits the texturized glass fibers in the muffler shell cavity.

13. The method according to claim 8, wherein upon filling the muffler shell cavity with a desired volume of glass fibers, a force is applied onto the preform product at the inlet end of the muffler shell cavity to define a substantially planar surface on the preform product.

14. The method according to claim 13, further including curing the preform product in the muffler shell.

15. A mold for forming a preform product, the mold having a first end and a second end, the mold comprising:
an outer mold portion having a longitudinal axis and a first end and a second end;
an inner mold portion disposed longitudinally within the outer mold portion, a substantially annular space between the inner mold portion and the outer mold portion defining a mold cavity, wherein the inner mold portion includes a closed first end, an open second end, and a plurality of apertures formed therethrough; and
an end plate disposed at the second end of the mold and having a centrally formed opening and a plurality of vacuum holes, wherein the centrally formed opening defines a passage into a cavity formed in the inner mold portion, and the vacuum holes define passages into the mold cavity; and
a vacuum source disposed adjacent the second end of the mold.

16. The mold according to claim 15, wherein the end plate is attached to one of the second end of the inner mold portion and the second end of the outer mold portion.

17. The mold according to claim 15, wherein the mold is structured and configured such that the centrally formed opening in the end plate and the apertures in the inner mold portion define a first suction flow path and the plurality of vacuum holes in the end plate defines a second suction flow path for suction created by the vacuum.

18. The mold according to claim 15, wherein the inner mold portion defines a circumferentially extending wall, and the plurality of apertures is formed through the wall.

19. The mold according to claim 15, wherein the outer mold portion defines a circumferentially extending wall having a plurality of apertures formed therethrough, and air-impermeable material disposed around an outer surface of the outer mold portion and covering the apertures.

20. The mold according to claim 15, further including a substantially annular cover removably mounted to the first end of the mold.

21. The mold according to claim 15, wherein the mold is structured and configured such that the vacuum source simultaneously applies suction through the open second end and the apertures of the inner mold portion, and through the vacuum holes of the end plate.

22. A method of forming a preform product, the method comprising:
filling a mold cavity with glass fibers, the mold cavity defining an inlet end, a second end opposite the inlet end, and a longitudinal axis; and
simultaneously applying suction to the mold cavity axially from the second end and further simultaneously applying suction radially outwardly through apertures formed in an outer circumferential wall of the mold, thereby forming a preform product.

23. The method according to claim 22, wherein the preform product has at least one bore formed longitudinally therethrough.
